(19) United States
(12) Patent Application Publication
(10) Pub. No.: US 2014/0347154 A1
(43) Pub. Date: Nov. 27, 2014

(54) INTERLEAVED PLANAR PCB RF TRANSFORMER

(71) Applicant: Coherent, Inc., Santa Clara, CA (US)

(72) Inventors: David P. SCHMELZER, West Hartford, CT (US); Frederick W. HAUER, Windsor, CT (US); Adrian PAPANIDE, Shelton, CT (US)

(21) Appl. No.: 13/899,315

(22) Filed: May 21, 2013

(51) Int. Cl. H01F 27/28

(52) U.S. Cl. CPC H01F 27/2876; H01F 27/2804; H01F 27/2847
USPC 336/170

(57) ABSTRACT

A radio-frequency (RF) planar transformer includes three spaced-apart, single-turn primary strip-windings connected electrically in parallel with each other. A one-turn secondary strip-winding is located between each adjacent pair of primary strip-windings. The secondary strip-windings are connected in electrical series with each other. The transformer functions as a transformer having a one-turn primary winding and a two-turn secondary winding.

### TECHNICAL FIELD OF THE INVENTION

The present invention relates in general to RF transformers for matching the drain impedance of RF power transistors to a load in RF power supplies for energizing gas discharge lasers such as carbon dioxide CO₂ lasers. The invention relates in particular to planar transformers with superposed primary and secondary loops separated by dielectric material.

### DISCUSSION OF BACKGROUND ART

The output power of commercial RF driven CO₂ lasers used for laser machining operations such as via drilling in printed circuit boards (PCBs) has been steadily increased by laser manufacturers in response to industry demand for higher product throughput. This increased laser-output power has required the development of RF power supplies with correspondingly increased power. This increased RF power has been facilitated by the development of high power RF transistors used as power amplifiers. In such amplifiers, the drain impedance of the transistors must be matched to a higher load impedance, typically 50 Ohms, of a transmission-line arrangement for transmitting the RF power to a laser. This impedance matching is accomplished by a RF transformer.

As RF transformers are less than 100% efficient. Increased power handling of a transformer will result in an increase in heat load which must be dissipated sufficiently for proper operation and lifetime of the transformer. Accordingly, in parallel with the transistor development, RF transformers have been developed to handle the higher power, particularly with regard to providing adequate heat dissipation.

This higher power requirement and correspondingly higher heat dissipation has led to the development of so-called planar transformers. These transformers have a primary single loop in the form of a wide, electrically conductive strip. This primary loop is arranged face to face with plural (typically two) secondary loops of correspondingly lesser width. The primary and secondary loops are separated, spaced apart and parallel, by a dielectric material. Such a transformer can easily be incorporated in a PCB on which other electrical components, including the RF transistors are assembled to form the power supply. Typically, such a PCB is supported on a chill plate which can be actively cooled for high power operations. This arrangement places the transformer in close proximity of the chill plate, which facilitates heat removal. Incorporating a transformer in this manner in a PCB also and incidentally provides for ease of manufacture and assembly.

FIG. 1 schematically illustrates a prior-art planar transformer 20 for use with power transistors and at an operating frequency of about 100 megahertz (MHz). Secondary electrode 22 has two turns (loops) and faces a U-shaped primary electrode having one turn to provide a 4 to 1 step up transformer. The primary electrode 24 is arranged face to face and spaced apart from a ground-plane electrode 26. The primary and secondary electrodes are spaced apart by a PCB-based dielectric layer 27 (shown in phantom). The primary electrode and ground plane are spaced apart by a dielectric layer 28 (also shown in phantom).

An outer end of the secondary electrode is connected eventually to RF discharge electrode of a CO₂ laser (not shown). The opposite end is connected via a via connection through layers 27 and 28 to the ground plane electrode the closed end of the primary electrode is connected to a DC voltage supply, here a 48 VDC supply. The two open ends of the primary electrodes are connected to corresponding drains of two power transistors (not shown) in a push-pull arrangement.

Only sufficient description of transformer 20 is provided here to illustrate the general form of a state-of-the-art planar transformer. A detailed description of transformer 20 is provided in U.S. Pat. No. 7,605,673, assigned to the assignee of the present invention, and the complete disclosure of which is hereby incorporated herein by reference.

Since the development of planar transformers exemplified by transformer 20, more powerful RF power transistors have been developed. RF power transistors with an output double that of the above referenced transistor are now commercially available. Generally double 4the output power is accompanied by one-half of the impedance at the transistor drain and two-times the current. The lower impedance means that transistor step up ratio must be increased for impedance matching. This reduces the transformer efficiency. The higher current and lower efficiency lead to higher operating temperatures.

While in it is possible to accommodate the higher current and lower efficiency by increasing the primary and secondary sizes and widths of a transformer such as above-described transformer 20, this would necessitate a greater physical separation of the transformer from the transistors, which would further reduce efficiency. Accordingly there is a need for a different planar transformer, still capable of PCB integration, but which can be operated efficiently at acceptable temperatures.

### SUMMARY OF THE INVENTION

In one aspect, a planar radio-frequency (RF) transformer in accordance with the present invention comprises first, second, and third primary strip-windings superposed, spaced apart, and connected electrically in parallel with each other, and first and second secondary strip-windings. The first secondary strip-winding located between and spaced-apart from the first and second primary strip-windings, the second secondary strip-winding located between and spaced apart from the second and third primary strip-windings. The first and second secondary strip-windings are electrically connected in series with each other.

In a preferred embodiment of the inventive transformer the primary strip-windings have a width greater than the secondary strip-windings and the primary and second strip-windings are superposed such that the primary strip-windings overhang the secondary strip-windings. The windings are separated by solid dielectric material.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a three-dimensional view schematically illustrating a prior-art planar RF transformer having a half-loop primary strip-winding spaced apart from a double loop, secondary strip-winding.

FIG. 2 is a three-dimensional view schematically illustrating a preferred embodiment of a planar RF transformer in in accordance with the present invention, including three superposed, spaced apart, primary, single strip-windings connected in parallel, and two secondary single strip-windings connected in series with each secondary winding between a different two adjacent ones of the secondary windings, and with primary input connections and secondary output connections on the same end of the transformer.

FIG. 2A is a plan view schematically a practical example of the transformer of FIG. 2 formed from a five layer (four substrates) printed circuit board (PCB).

FIG. 2B is a partly shaded longitudinal cross-section view seen generally in the direction 2B-2B of FIG. 2A schematically illustrating details of the five layer PCB.

FIG. 3 is a plan view schematically depicting another embodiment of a planar RF transformer in accordance with the present invention similar to the transformer of FIGS. 2A and 2B, but with primary input connections and secondary output connections on opposite sides of the transformer.

FIG. 4 is a plan view schematically depicting yet another embodiment of a planar RF transformer in accordance with the present invention similar to the transformer of FIG. 3 but with primary input connections and secondary output connections on the same side of the transformer.

FIG. 5 is a three dimensional view schematically illustrating still another embodiment of a planar RF transformer in in accordance with the present invention similar to the transformer of FIGS. 2A and 2B but with edges thereof copper plated to improve heat transfer through the transformer.

FIG. 6A is a partly-shaded cross sectional view seen generally in the direction 6-6 of FIG. 5 schematically illustrating one preferred configuration of a PCB for supporting the transformer.

FIG. 6B is a partly-shaded cross sectional view seen generally in the direction 6-6 of FIG. 5 schematically illustrating another preferred configuration of a PCB for supporting the transformer.

FIG. 7 is a three-dimensional view schematically illustrating still yet another embodiment of a planar RF transformer in in accordance with the present invention similar to the transformer of FIGS. 2A and 2B but with a plurality of spaced apart strips extending outward there from for encouraging heat dissipation laterally from the transformer.

FIG. 8 is a is a three-dimensional view schematically illustrating one further embodiment of a planar RF transformer in in accordance with the present invention integrated into a 5-layer PCB, the transformer having an electrode configuration similar to the transformer of FIG. 3 and being supported on a base backed by a chill plate with a space in the base between the PCB and chill plate filled with a compressible thermally conductive dielectric material.

FIG. 8A is a partly shaded cross-section view seen generally in the direction 8A-8A of FIG. 8 schematically illustrating further detail of the integrated transformer of FIG. 8

### DETAILED DESCRIPTION OF THE INVENTION

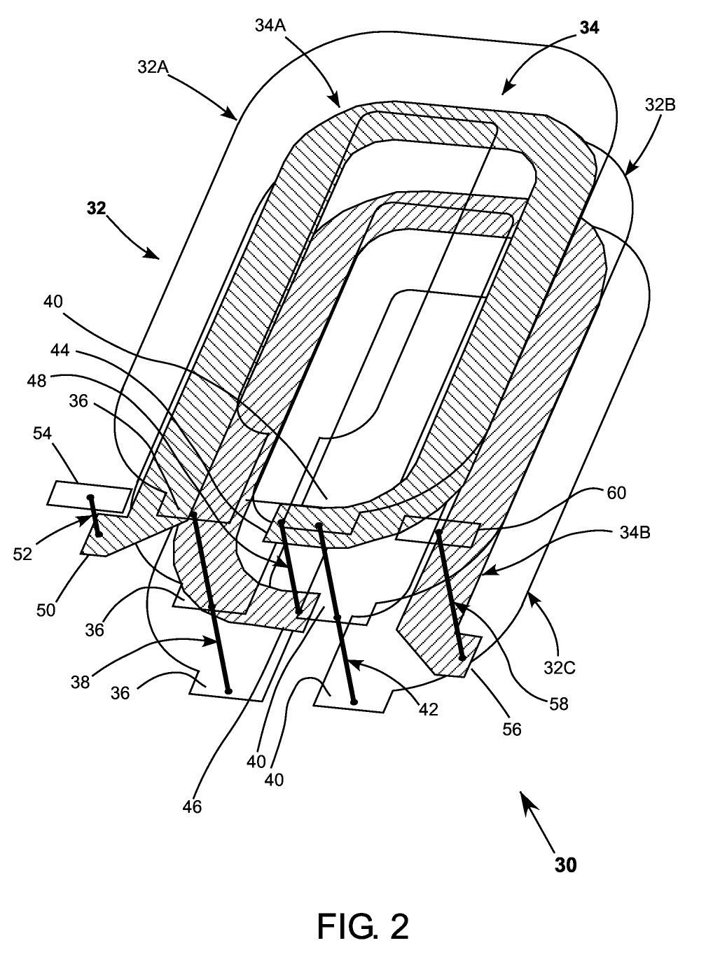

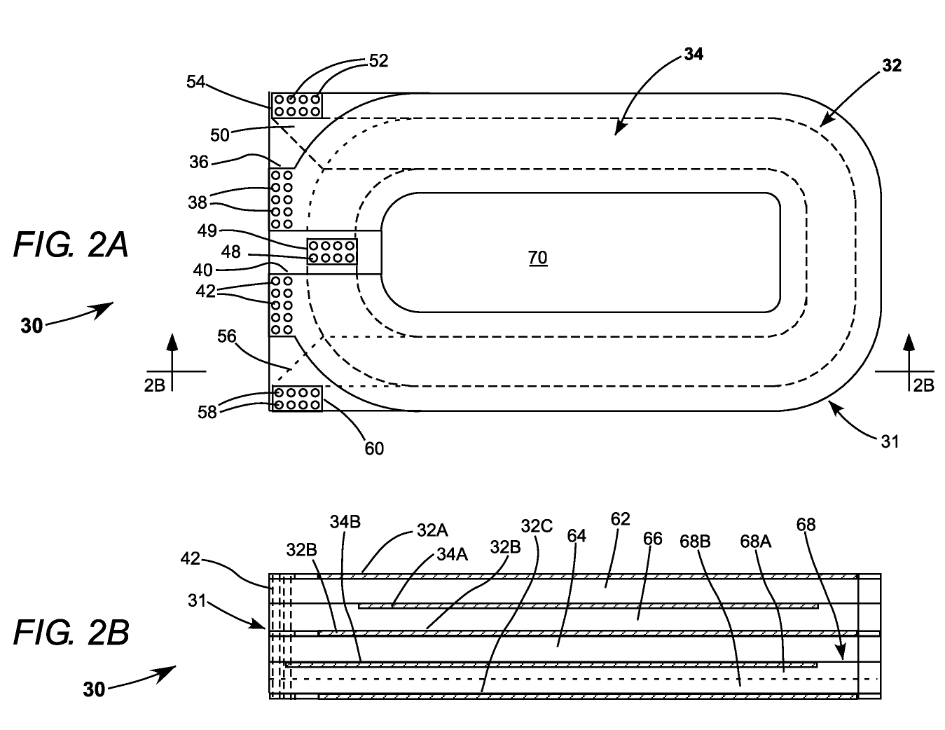

Referring now to the drawings, wherein like components are designated by like reference numerals, FIG. 2 schematically illustrates a preferred embodiment 30 of a planar RF transformer in in accordance with the present invention. The transformer is described herein as a step-up transformer which would be used for impedance matching between push pull transistors and a load as described above.

Transformer 30 includes a primary electrode assembly 32 including three superposed, spaced-apart, primary single strip-windings 32A, 32B, and 32C. These strip-windings can be defined as having a generally rounded-rectangular shape or a racetrack shape. These winding strips are depicted as “transparent” in FIG. 2 for convenience of illustration. Strips 32A, 32B, and 32C are single-turn, open loops. Corresponding ends 36 of the loops are electrically connected together by a conductor 38. Corresponding ends 40 of the loops are electrically connected together by a conductor 42. The three primary windings, being thus connected electrically in parallel, function as a single winding having three-times the area of any one of the connected windings. Connected ends 36 and connected ends 40 provide the primary inputs to the transformer, which, in the contemplated use, would be connected to corresponding drains of a push-pull transistor pair.

It should be noted, here, that conductors 38 and 42, and other such conductors depicted in FIG. 2, are depicted as single conductors for convenience of description. In practice, each conductor would be formed from plural connections to provide adequate current carrying capacity, and thermal transfer between the strip-windings. Such plural connections are discussed further herein below with reference to practical examples of the inventive RF transformer.

A secondary electrode assembly 34 includes two superposed, spaced-apart, secondary strip-windings 34A, and 34B. Each winding is in the form of an open loop. The loops are interleaved with (and spaced apart from) the parallel-connected primary loops. Secondary loop 34A is located between primary loops 36A and 36B. Secondary loop 34B is located between primary loops 36B and 36C. Distal end 44 of loop 34A is electrically connected to proximal end 46 of loop 34B by a conductor 48. This connects the two loops in series, creating a two-turn secondary of the transformer, with one of the connected primary loops between the two secondary turns (loops). Proximal end 50 of secondary loop 34A provides one of two secondary outputs of the transformer. Distal end 56 of secondary loop 34B provides the other secondary output.

Proximal end 50 of secondary loop is connected by a conductor 52 to a terminal pad 54. Distal end 56 of secondary loop 34 B is connected by a conductor 58 to a terminal pad 60. Terminal pads 54 and 60 are in the plane of primary winding 32A. Conductor 52 and 58 can be extended to corresponding terminal pads (not shown) in the plane of primary winding 32C. This is for compatibility with printed circuit board (PCB) assembly of the transformer, a description of which is set forth below with reference to FIG. 2A and FIG. 2B.

Here, transformer 30 is constructed from a 5-layer, i.e., five conductor-patterned layers, PCB 31 (see in particular FIG. 2B). PCB board 31 has 5 dielectric spacers spacing the 5 conductive pattered layers. Spacers 62 and 64 are preferably made from PCB core material such as RO4350 available from Rogers Corporation, of Rogers, Conn. Spacer 62 carries primary winding 32A and secondary winding 34A. Spacer 64 carries primary winding 32B and secondary winding 34B.

Spacer 66 is preferably made from a pre-impregnated (resin impregnated) low-temperature thermosetting material generally referred to in the electronic art as “prepeg” material. Such a material can be stored in uncured form and in the construction of PCB 31 can be compressed between the core layers prior to thermosetting to optimize physical contact. Prepeg material is commercially available from the Taconic Corporation of Petersburgh, N.Y. Prepeg material is also available as RO4450 from the above-referenced Rogers Corporation. Spacer 68 is formed from a combination prepeg material 68A and PCB core 68B. The PCB core carries primary winding 36C.

Top and bottom conductors such as primary windings 32A and 32C are preferably etch-patterned from 2.0 ounce (2 oz) of copper cladding per square foot, with electroless-nickel, immersion-gold plating. This cladding has a total thickness of about 2.4 thousands of an inch (mils). Other conductors are etch-patterned from 1.0 oz per square foot cladding, which has a thickness of about 1.4 mils Spacer thickness is preferably about 14 mils and 20 mils. Preferably the thickness of the spacers can be selected to provide equal spacing between the transformer windings.

FIG. 2A is essentially a plan view from above of the transformer of FIG. 2. The above-referenced plural conductors between transformer windings are depicted in FIG. 2A and designated by the same reference numeral as the corresponding single conductors of FIG. 2. In FIG. 2A conductors 48 serially connecting the two secondary loops are terminated by a terminal pad 49. All of the plural conductors pass through corresponding via-holes, not specifically designated, passing through PCB 31. There can be corresponding terminal pads 54, 60 and 49 on the opposite (not visible) side of the transformer. Further in the arrangement of FIG. 2A, a space 70A is optionally formed in a region bounded by the inner edge of the primary windings by machining away the PCB in this region. An advantage of this is discussed further herein below.

Regarding widths of the primary and secondary winding strips, the primary winding strips preferably have a width between about 100 mils and about 200 mils. The secondary windings preferably have a width between about 40% and 90% of the width of the primary windings and are preferably arranged such that primary windings “overhang” the secondary windings on each side as depicted in FIG. 2A. This is to optimize transmission-line (electromagnetic) coupling of the primary to the secondary. Regarding other dimensions, the overall length of the transformer windings in the preferred rounded-rectangular form depicted is preferably between about 900 mils and about 1200 mils, for operation at frequencies between about 80 megahertz (MHz) and about 120 MHz.

These above-discussed exemplary dimensions are provided for a transformer in accordance with the present invention capable of operating at an average power of about 600 W and peak power of 1500 W. From the detailed description of the inventive transformer presented herein, those skilled in the art may determine other dimensions for the same or other powers without departing from the spirit and scope of the present invention. Such determinations can be made, for example, using RF circuit simulation software such as ADVANCED DESIGN SYSTEM (ADS), available from Agilent Technologies Inc., of Palo Alto, Calif.

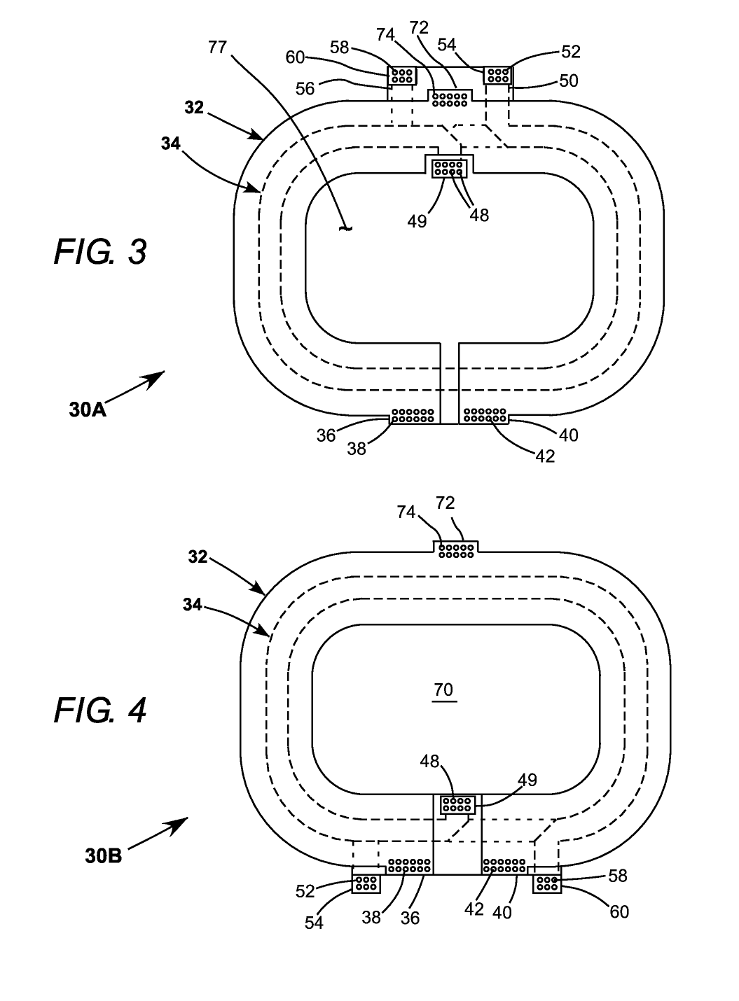

Exemplary different electrode configurations of the inventive transformer are schematically depicted in FIG. 3 (transformer 30A) and FIG. 4 (transformer 30B). Transformers 30A and 30B have the same superposed interleaved strip-winding arrangement of FIG. 2, and are constructed generally in the manner described with reference to FIG. 2A. The transformers differ from transformer 30 of FIG. 2 in aspect ratio, or location of primary inputs and secondary outputs. To facilitate comparison, and to avoid duplicative description, like components in each transformer are designated by the same reference numeral used in above described transformer 30. Only certain differences between the transformers are discussed are described below.

In FIG. 3, transformer 30A has a shorter overall length and a wider overall width, i.e., a less elongated aspect ratio than transformer 30 of FIG. 2A. The primary input terminals 36 and 40 are on one long side of the transformer, and the secondary output terminals 54 and 60 are on the opposite long side of the transformer.

Additional in transformer 30A is a virtual ground terminal 72 of the primary windings. There is one of these on the two primary windings that are not visible. The terminals are electrically connected together by plural conductors 74. Terminal 72 can be used for supplying DC power to transistors (not shown) connected to primary input terminals 36 and 40. Also in transformer 30A, the space 77 enclosed by the primary windings is not optionally machined away. In this space, plating is simply etched away (on all conductor layers) leaving only bare (dielectric) spacer material.

In transformer 30B of FIG. 4, the space 70 enclosed by the primary windings is machined away in the manner of the same space in transformer 30 of FIG. 2A. In transformer 30B, the primary input terminals 36 and 40, and the secondary output terminals 54 and 60 are on one long side of the transformer. Virtual ground terminal 72 is on the opposite long side of the transformer. Here again it should be noted that transformers 30A and 30B are merely two examples of alternate configurations of the inventive transformer and should not be construed as limiting the present invention.

The embodiments of the inventive transformer discussed above are configured as free-standing components for mounting on a chill-plate (heat-sink) cooled PCB together with other electronic components such a transistors, capacitors, inductors and the like which may be required to form a complete RF power-supply. It has been determined that a PCB on which the transformer is mounted preferably has a minimum dielectric thickness of at least about 70 mils between a top (conductor) surface thereof and the heat-sink or chill plate. This minimum thickness is required for efficient operation of the transformer. Because of this, careful consideration has been given to arrangements for promoting transfer of heat through the transformer itself, and to how that heat is conducted through the PC board on which the transformer is supported.

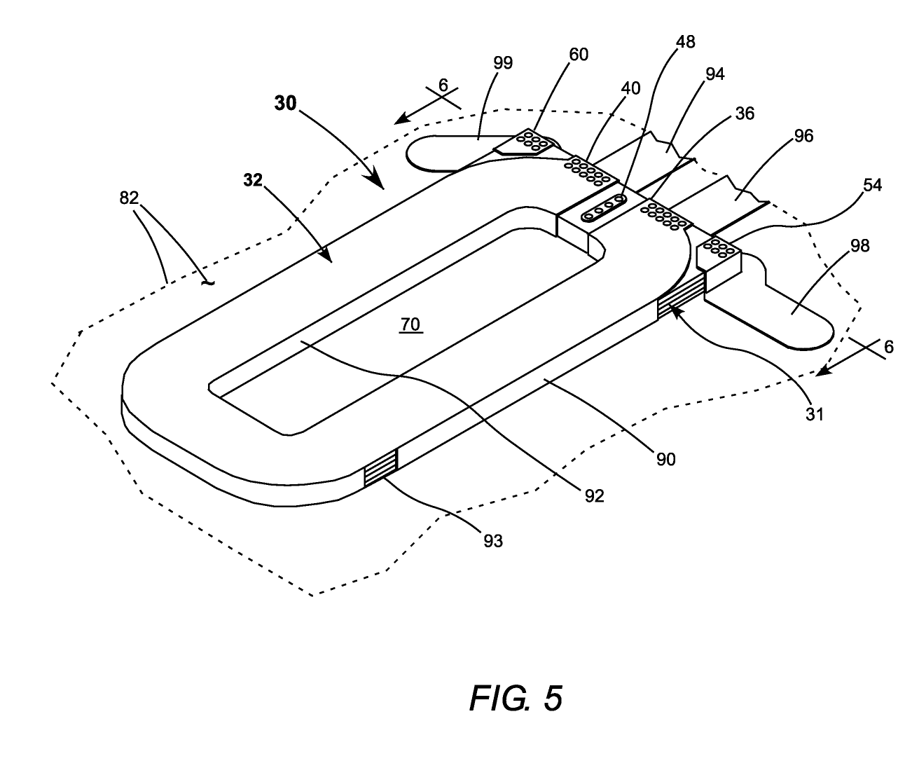

By way of example, FIG. 5 schematically illustrates an example of transformer 30 of FIG. 2A mounted on a surface portion 82 (outlined in phantom) of a PCB 80 (body thereof not shown). On surface 82, conductor strips 98 and 99 are defined on surface 80 to which secondary output terminals 54 and 60 of the transformer are soldered. Conductor strips 94 and 96 are defined to which primary input terminals 36 and 40 are soldered, in addition to the lower primary winding, in order to encourage heat flow between the three primary windings of the transformer, copper plating 90 is provided on the outer edge of the transformer and plating 92 is provided on the inner edge. Plating is discontinued between the primary edges and the secondary output terminals, exposing PCB 31 as indicated. This discontinuity in the edge-plating, of course, is for preventing the edge-plating from shorting the primary windings to the secondary outputs. A discontinuity 93 in the edge plating is provided for a support tab (not shown) used in the PCB panel mounting.

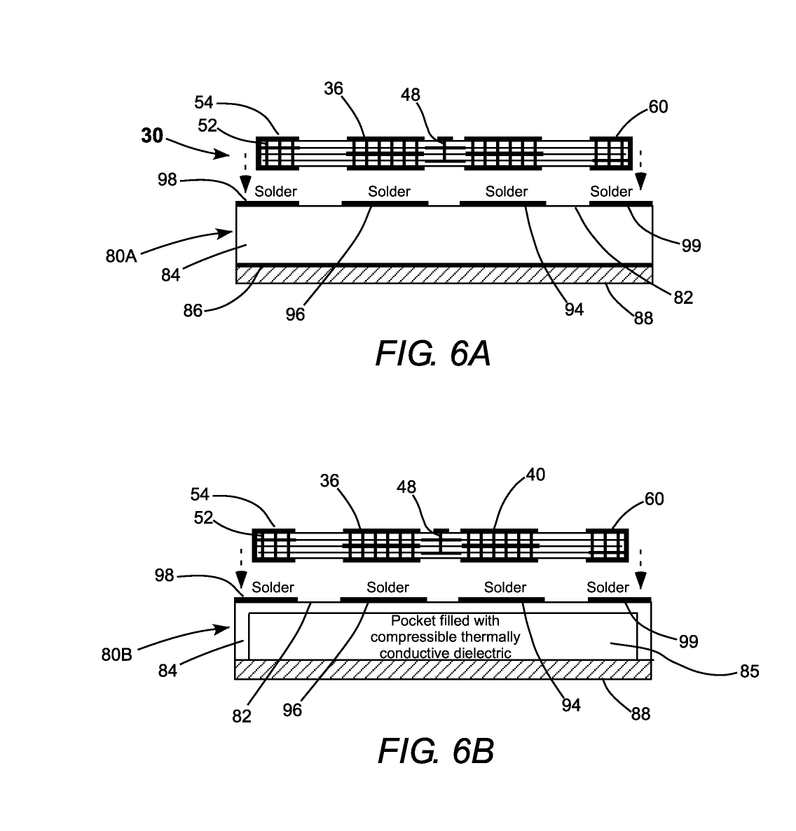

FIG. 6A and FIG. 6B are simplified partially-shaded cross-section views seen generally in the direction 6-6 of FIG. 5 schematically illustrating configuration options for PCB 80. In each case, transformer 30 is shown being soldered to contacts on the PCB is depicted in FIG. 5.

In FIG. 6A, the PCB, here designated as PCB 80A, has a spacer body 84 of a core dielectric material such as the above-discussed RO4350/4450. This spacer is backed by 2 oz copper plating 86, providing a ground plane to which is bonded a chill plate 88 preferably also of copper. In FIG. 6B, PCB 80B has a pocket 85 machined into dielectric spacer material 84. This pocket is filled with a compressible thermally conductive dielectric material. One suitable such material is THERM-A-GAP 976 available from Parker Chomerics of Woburn, Mass. This material has a dielectric constant similar to that of RO4350 core material but has a thermally conductivity of 6.5 Watts per meter-Kelvin (W/m-K) which is almost 10 times higher than that of RO4350. By way of example a 65 mil deep pocket was machined into a 75 mil-thick RO4350 board can increase the above-reference average power handing capability of 600 W to as much as 1200 W.

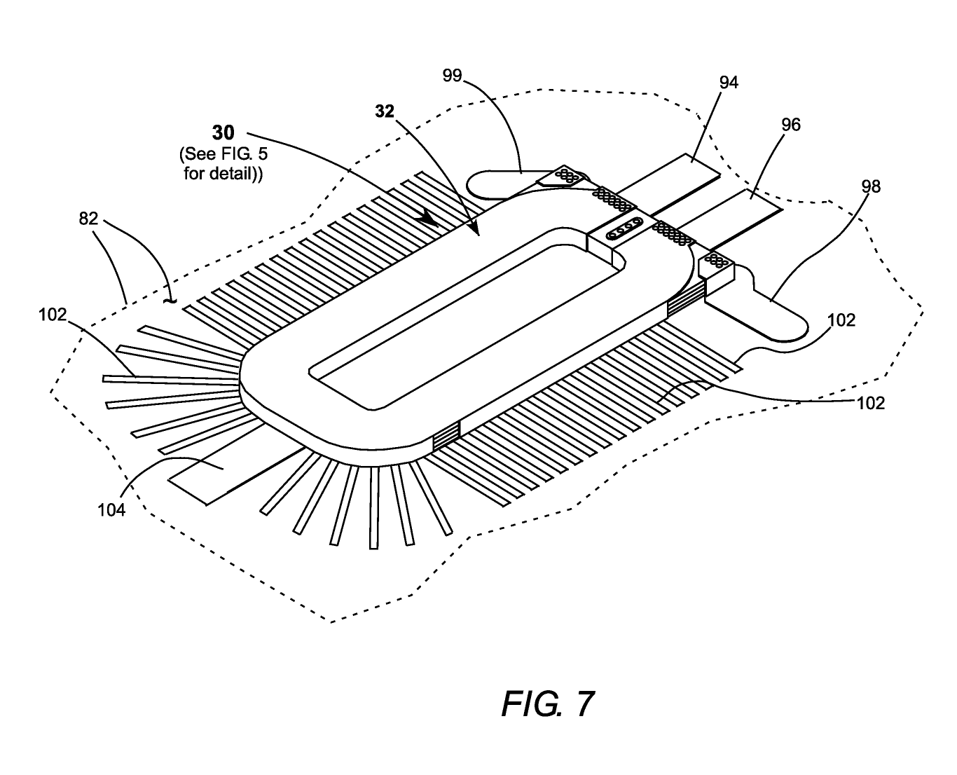

FIG. 7 schematically illustrates another PCB board option for encouraging heat dissipation from the inventive transformer. Here, transformer 30 is configured and mounted as depicted in FIG. 5. Additionally, a plurality of thin copper (thermally conductive) strips 102, outwardly extending from the primary winding, is provided for conducting heat laterally away from transformer 30. These strips extend from the primary contact layer (not visible) on the PCB. This, cooperative with the edge-plating, puts the strips in thermal communication with the primary strip-windings. An additional wide strip 104 at the distal end of the transformer also provides a primary center-tap connection as discussed above.

It has been determined using RF and thermal simulation software that by keeping the strips narrow and not too closely spaced, the arrangement of fins does not significantly add shunt capacitance to the primary winding and does not adversely affect operating efficiency of the transformer. A preferred width for the strips is about 20 mils. A preferred length for the strips is about 500 mils. A preferred minimum spacing of the strips is about 20 mils. Thickness of the strips is about 2.4 mils, consistent with the above-referenced 2 oz copper-based cladding.

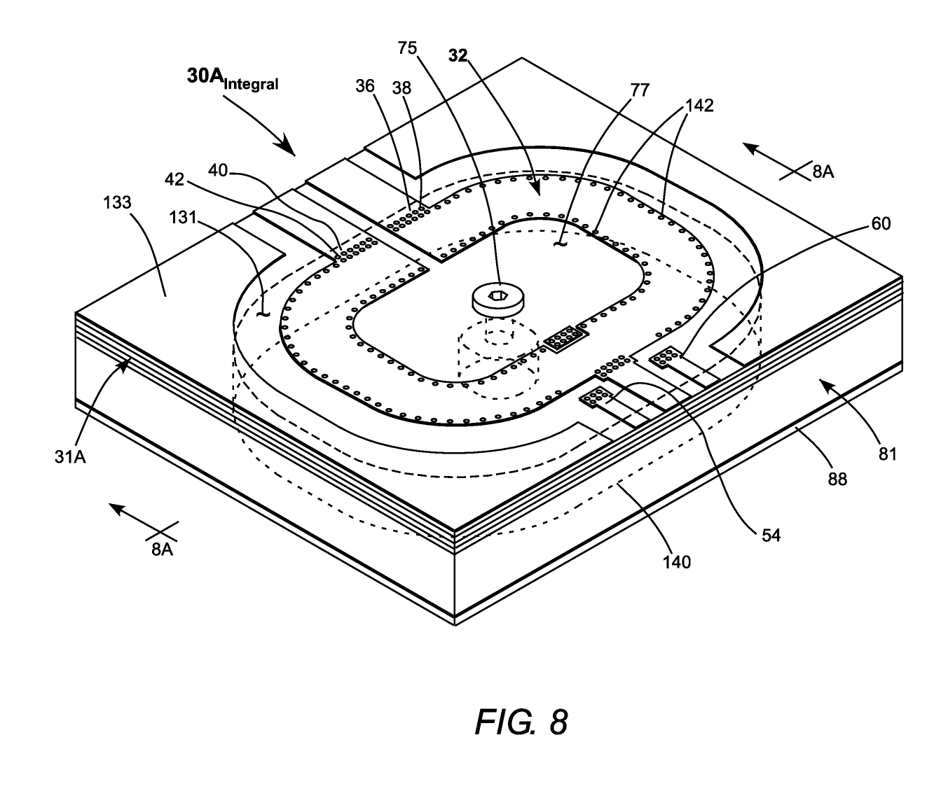

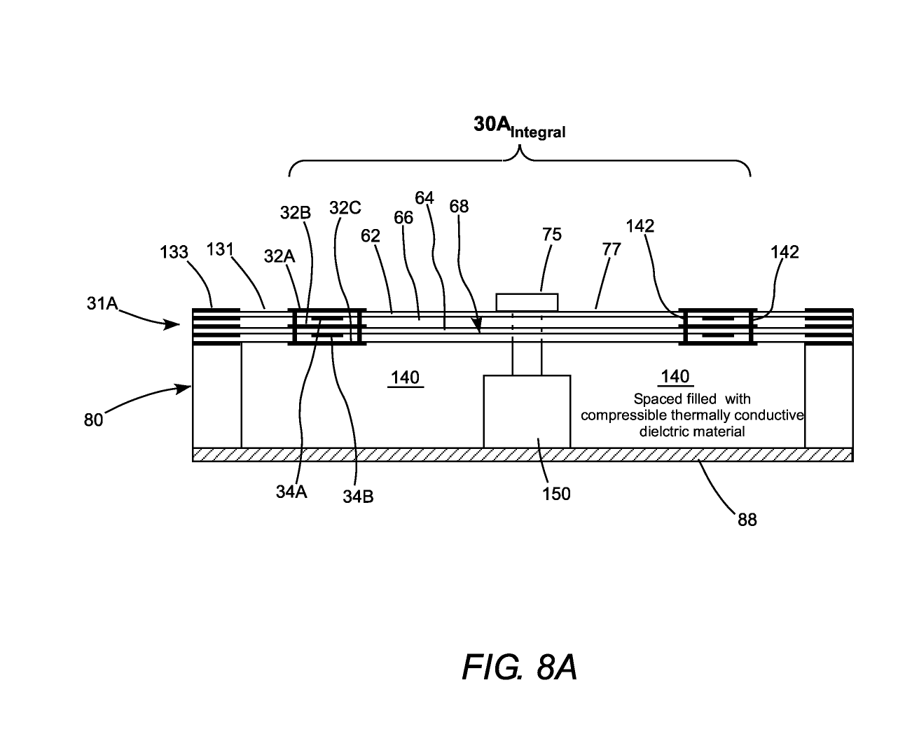

It is contemplated that further improvement in thermal management of the inventive transformer can be provided by integrating the transformer with a PC board on which above-discussed other necessary electronic components are mounted. A description of one integrated embodiment of the inventive transformer is set forth below with reference to FIG. 8 and FIG. 8A.

Here, the integrated transformer is designated 30A_{Integral}. The transformer itself is configured (except for the surrounding PC board) similar to transformer 30A described above with reference to FIGS. 2, 2A, and 3. The same reference numerals are used to designate those inventive transformer features already described. The extent of the 5-layer PC board 31 illustrated is just sufficient to describe the integration of the transformer, particularly with regard to cooling arrangements. Those skilled in the art will recognize that the board may have a more extensive surface dependent on whatever additional components are to be mounted thereon. Those skilled in the art will also recognize that outside the transformer, other conductive layers of the board may be redundant depending on circuit complexity.

Regarding additional features of the integrated transformer, a racetrack-shaped insulating channel 131 in the conductive board layers (only the top layer visible in FIG. 8) serves to generally electrically isolate the transformer from the surrounding plating 133. Secondary windings, not visible in FIG. 8 are similarly isolated by larger racetracks. Primary and secondary terminals 36, 40, 54, and 60, and center-tap terminal 72 are extended to provide integral conductor to components (not shown) connected thereto. A plurality of through (via) connections 142 around the outer and inner edges of the primary winding strips encourages heat transfer between the primary windings. This is functionally equivalent to the edge-plating of the transformer of FIG. 5.

The PCB in which the inventive transformer is integrated is mounted on a base 81 which can be made from metal or dielectric material. Base 81 is backed by a metal plate 88. If a metal is chosen for base 81, which is preferred, then the combination of the base and plate 88 can be considered a heat sink. In this latter case, any surrounding electronic circuitry outside the transformer will use the top metal cladding of the PCB for signal and metal layer 88 for ground.

A rounded rectangular aperture 140 is machined through base 81, preferably extending laterally beyond the transformer “footprint” as illustrated in FIGS. 8 and 8A. This aperture covered by plate 88 and is filled with the above-described compressible conductive dielectric, which because of this integrated arrangement can now be in immediate thermal contact with the transformer. The advantage of this compared with the stand-alone transformer arrangement of FIG. 6B is substantial, noting that in the stand-alone arrangement with the exemplary thicknesses discussed, the remaining thickness core spacer immediate below the transformer can have almost three-times higher thermal resistance than that of the thermal gap-filler material.

A feature provided to compress the gap-filler material for optimizing thermal communication is a screw 75, bearing on surface 77, and extending through the center of the transformer into a boss 150 attached to heat sink 88. This provides a compression means for the gap-filler material and can maintain rigidity of the assembly. In the case of a metal base 81, the gap-filler material provides thermal communication between the transformer, base 81 and plate 88 while electrically isolating the transformer from the base and the plate.

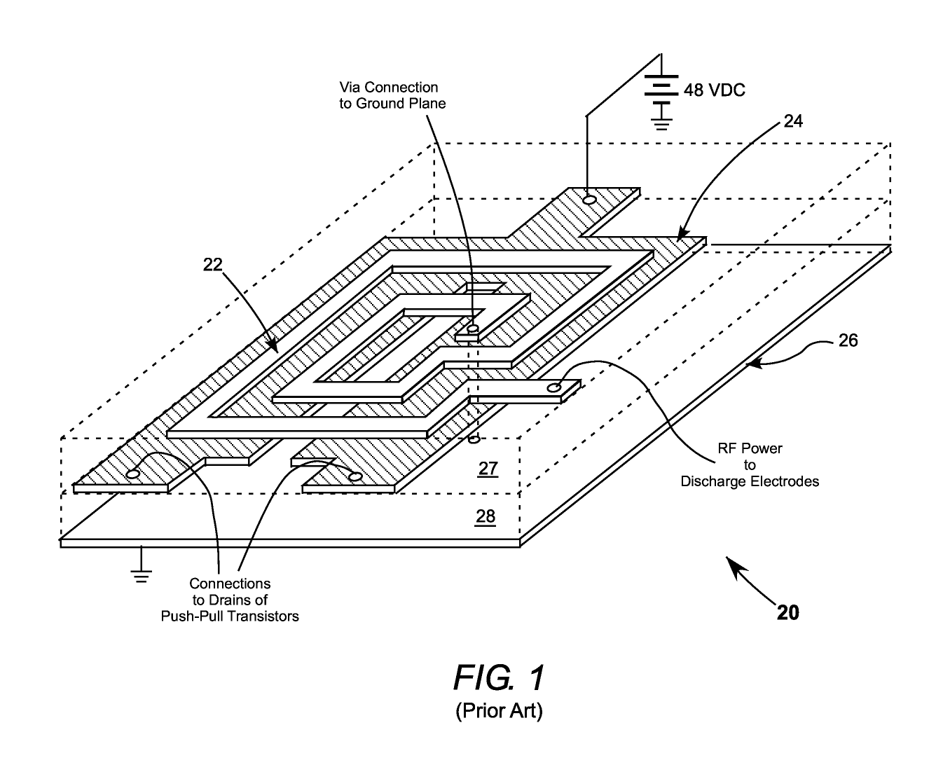

In summary, the “vertical” (superposed) spaced-apart stacking of electrodes and the attendant electrical connection provides a means of extending the electrode area of a planar transformer, for increasing power handling, without increasing the transformer footprint. In fact for a given power, inventive transformer in accordance with any one of the embodiments described above can have a footprint less than 50% of that of a the prior-art planar transformer discussed above with reference to FIG. 1.

The relatively narrow primary windings of the inventive transformer provide for lower shunt capacitance and high inductance relative to ground, reducing losses. Control of coupling impedance between primary and secondary is facilitated by varying the width of secondary windings or varying the spacing of the windings by varying the thickness of the dielectric layers separating the windings. The inventive transformer can be operated at higher frequency that prior art transformers because of the lower shunt capacitance. These advantages come with a challenge to heat-sinking arrangements. That challenge, however, is adequately mitigated by above-described inventive arrangements alone or in combination.

In all embodiments of the inventive transformer described above, the transformer is arranged as a 4:1 step-up transformer with three spaced-apart single-turn primary strip-windings connected in parallel with each other, i.e., still effectively a one-turn primary. Two single turn secondary strip-windings, one between and spaced apart from each of the primary strip-windings, with the secondary strip-windings are connected in series with each other, providing a two turn secondary. If a higher step-up ratio is required, other configurations in accordance with the present invention are possible, in theory at least.

By way of example, four spaced apart primary strip-windings could be connected in parallel with three interleaved secondary strip-windings connected in series to provide in effect a one-turn primary with a three-turn secondary. Three spaced-apart one-turn primary strip-windings connected in parallel could be combined with two interleaved two-turn secondary strip-windings connected in series to provide in effect a one-turn primary and a four-turn secondary. An interleaved two-turn secondary strip-winding may be connected in series with an interleaved single-turn secondary strip-winding to provide in effect a three-turn secondary strip-winding. These and other combinations of parallel-connected primary strip-windings and interleaved, series-connected strip-windings may be used without departing from the spirit and scope of the present invention.

In conclusion, the present invention is described above in terms of a preferred and other embodiments. The invention, however, is not limited to the embodiments described and depicted herein. Rather, the invention is defined by the claims appended hereto.

1. A radio-frequency (RF) transformer, comprising:
first, second, and third primary strip-windings superposed, spaced apart, and connected electrically in parallel with each other; and
first and second secondary strip-windings, the first secondary strip-winding located between and spaced-apart from the first and second primary strip-windings, the second secondary strip-winding located between and spaced apart from the second and third primary strip-windings, with the first and second secondary strip-windings electrically connected in series with each other.

2. The transformer of claim 1, wherein the primary and secondary strip-windings are each single-turn windings.

3. The transformer of claim 2, wherein the primary strip-windings each have a first strip-width and the secondary strip-windings each have a second strip-width less than the first strip-width, and wherein the primary and secondary strip-windings are superposed such that the primary strip-windings overhang the secondary strip-windings.

4. The transformer of claim 3, wherein the second strip-width is between about 40% and about 90% of the first strip width.

5. The transformer of claim 4, wherein there are only first, second, and third primary strip-windings, and only first and second secondary strip-windings, whereby the transformer functions effectively as a transformer having effectively one primary turn and two secondary turns.

6. The transformer of claim 1, wherein the primary and secondary strip-windings are spaced apart by solid dielectric material.

7. The transformer of claim 6, wherein the solid dielectric material between the first primary strip-winding and the first secondary strip-winding, and between the second primary strip-winding and the second secondary strip-winding is a PCB core material, the solid dielectric material between the first secondary strip-winding and the send primary strip-winding is a pre-impregnated thermo-cured dielectric material, and wherein the dielectric material between the second secondary strip-winding and the third primary strip-winding is a combination of the pre-impregnated thermo-cured dielectric material and the PCB core material, with the thermo-cured material in contact with the second secondary strip-winding, and the PCB core material in contact with the third primary strip-winding.

8. The transformer of claim 7, wherein the thickness of the dielectric materials separating the primary and secondary strip-windings is selected such that the primary and secondary strip-windings are about equally spaced apart.

9. The transformer of claim 6, wherein the transformer is configured as a stand-alone unit for mounting on a PCB.

10. The transformer of claim 6, wherein the transformer is configured as an integral part of a PCB on which other electronic components cooperative with the transformer can be mounted.

11. A radio-frequency (RF) transformer, comprising:
first, second, and third single-turn, primary, strip-windings each thereof having first and second ends, the strip-windings being superposed, spaced apart, with the first ends thereof electrically connected to a first input-terminal of the transformer and the second ends thereof electrically connected to a second input-terminal of the transformer to define a parallel connection between the primary strip-windings;
first and second single-turn secondary strip-windings each thereof having first and second ends, the first secondary strip-winding located between and spaced-apart from the first and second primary strip-windings, the second secondary strip-winding located between and spaced apart from the second and third primary strip-windings, with the second end of the first secondary strip-winding electrically connected to the first end of the second secondary step-winding, with the first end of the first secondary strip-winding electrically connected to a first output-terminal of the transformer, and the second end of the second primary strip-winding electrically connected to a second output-terminal of the transformer to define a series connection between the secondary strip-windings; and
wherein the primary and secondary strip-windings are spaced apart by dielectric material.

12. The transformer of claim 11, wherein the primary strip-windings and the secondary have an open-ended, rounded-rectangular shape and have inner and outer edges, the primary strip-windings each having a first strip-width and the secondary strip-windings each having a second strip-width less than the first strip-width, and wherein the primary and secondary strip-windings are superposed vertically aligned with each other such that the primary strip-windings overhang the secondary strip-windings.

13. The transformer of claim 12, wherein the input-terminals and output-terminals are arranged on the same side of the transformer.

14. The transformer of claim 12, wherein the input-terminals are arranged on one side of the transformer, and the output-terminals are arranged on an opposite side of the transformer.

15. The transformer of claim 12, further including a first plurality of conductors spaced apart around and thermally and electrically connecting the outer edges of the primary strip-windings, and a second plurality of conductors spaced apart around and thermally and electrically connecting the inner edges of the primary strip-windings.

16. The transformer of claim 12, wherein the transformer has the shape of a loop having upper and lower opposite surfaces and inner and outer edges corresponding to inner and out edges of the primary strip-windings, the first primary winding being on the upper surface of the transformer, and the third primary winding being on the lower surface of the transformer, with inner and outer edges of the loop being metal-plated such that the metal plating provides thermal communication between the first second and third primary strip-windings.

17. The transformer of 12, wherein the transformer is mounted with the lower surface thereof on a surface of a dielectric base-layer, the surface of the dielectric base layer having a plurality of metal strips thereon, the metal strips being in thermal contact with the third primary strip-winding, spaced-apart and extending outward therefrom, for conducting heat away from the transformer.

18. A radio-frequency (RF) transformer formed in a printed circuit board (PCB), the transformer comprising:
first, second, and third single-turn, primary, strip-windings each thereof having first and second ends, the strip-windings being superposed, spaced apart, with the first ends thereof electrically to a first input-terminal of the transformer and the second ends thereof electrically connected to a second input-terminal of the transformer to define a parallel connection between the primary strip-windings;
first and second single-turn secondary strip-windings each thereof having first and second ends, the first secondary strip-winding located between and spaced-apart from the first and second primary strip-windings, the second secondary strip-winding located between and spaced apart from the second and third primary strip-windings, with the second end of the first secondary strip-winding electrically connected to the first end of the second secondary step-winding, with the first end of the first secondary strip-winding electrically connected to a first output-terminal of the transformer, and the second end of the second primary strip-winding electrically connected to a second output-terminal of the transformer to define a series connection between the secondary strip-windings; and
wherein the primary and secondary strip-windings are spaced apart by dielectric spacer layers of the PCB, the first primary strip-winding is on an upper surface of the PCB, and third primary strip-winding is on a lower surface of the PCB.

19. The transformer of claim 18, wherein the PCB including the transformer is supported on a dielectric base-layer, the base layer being backed by a metal plate, and wherein there is an aperture extending through the base-layer below the transformer extending laterally beyond the transformer, and covered by the metal plate, the aperture being filled with a thermally conductive dielectric material to provide thermal communication between the transformer and the metal plate.

20. The transformer of claim 18, wherein the PCB including the transformer is supported on a metal base-layer, the base layer being backed by a metal plate, and wherein there is an aperture extending through the metal base-layer below the transformer, extending laterally beyond the transformer and covered by the metal plate, the aperture being filled with a thermally conductive dielectric material to provide thermal communication between the metal base layer and the metal plate while electrically insulating the transformer from the metal base-layer and the metal plate.
